(19) United States
(12) Patent Application Publication
(10) Pub. No.: US 2014/0047177 A1
(43) Pub. Date: Feb. 13, 2014

(54) MIRRORED DATA STORAGE PHYSICAL ENTITY PAIRING IN ACCORDANCE WITH RELIABILITY WEIGHTINGS

(71) Applicants: DEEPAK R. GHUGE, HINJEWADI (IN); SHAH MOHAMMAD REZAUL ISLAM, TUCSON, AZ (US); SANDEEP R. PATIL, HINJEWADI (IN); RIYAZAHAMAD M. SHIRAGUPPI, HINJEWADI (IN)

(72) Inventors: DEEPAK R. GHUGE, HINJEWADI (IN); SHAH MOHAMMAD REZAUL ISLAM, TUCSON, AZ (US); SANDEEP R. PATIL, HINJEWADI (IN); RIYAZAHAMAD M. SHIRAGUPPI, HINJEWADI (IN)

(73) Assignee: INTERNATIONAL BUSINESS MACHINES CORPORATION, ARMONK, NY (US)

(21) Appl. No.: 13/572,447

(22) Filed: Aug. 10, 2012

(51) Int. Cl. G06F 3/06

(52) U.S. Cl. CPC G06F 3/0689
USPC 711/114

(57) ABSTRACT

A mirrored data storage system with a plurality of data storage physical entities (drives) arranged in mirrored pairs in accordance with reliability weightings that have been assigned to each of the drives. Each mirrored pair comprises one drive with at least a median and greater reliability weighting, and one drive with at least a median and lesser reliability weighting. In an example, the assigned reliability weightings are sorted into descending order; with the drives having weightings in the upper half of the sorted order assigned to a first set with greater reliability weighting, and the drives having weightings in the lower half of the sorted order assigned to a second set with lesser reliability weighting. Each mirrored pair has one drive selected from the first set and one drive selected from the second set.

### FIELD OF THE INVENTION

This invention relates to data storage entities arranged in mirrored pairs.

### BACKGROUND OF THE INVENTION

Data storage systems may be arranged to provide data storage with varying degrees of data redundancy. RAID (redundant array of independent disks) is a term applied to pluralities of data storage physical entities, such as disk drives or hard disk drives, arranged to add a redundancy to the data so that the data can be reconstructed even if there is a limited loss of data. A RAID system typically comprises more than one data storage physical entity and the limited loss of data can be up to a catastrophic loss of data on one or more of the data storage physical entities. Numbers are applied to various versions of RAID, some of which copy or “mirror” the data, and others provide “parity” RAID, where data is stored on more than one data storage drive, the data is summed and the parity (which makes the sum of the data, and the parity, equal to all the same bit) is stored separately from the data.

An example of a mirrored RAID system is a RAID-1 which comprises an even number of data storage drives, and where data stored on one data storage drive is copied (mirrored) on another data storage drive, forming a mirrored pair. Thus, if one data storage drive fails, the data is still available on the other data storage drive. Typically, all of the data storage drives to be used in a RAID are selected randomly to be very similar to each other.

### SUMMARY OF THE INVENTION

Mirrored data storage systems, mirrored arrangements of data storage physical entities (drives), methods and computer program products are provided for assigning mirrored pairing of drives.

One embodiment of a mirrored data storage system has a RAID control system; and a plurality of data storage physical entities (drives) arranged in mirrored pairs in accordance with reliability weightings assigned to each of the plurality of drives. Each mirrored pair comprises one of the drives with at least a median and greater reliability weighting, and one of the drives with at least a median and lesser reliability weighting.

In a further embodiment, the plurality of drives comprises an even number, and any drive having a median reliability weighting is arranged at the side of a mirrored pair required to equalize the number of drives at each side of the arrangement.

In another embodiment, the mirrored pairs are arranged as a RAID 01 data storage system having two groups of the drives, a first group of the drives of median and greater reliability weightings of the mirrored pairs, and the second group of the drives of median and lesser reliability weightings, to form the mirrored pairs.

In still another embodiment, the paired mirrored sets are arranged as a RAID 10 data storage system having a plurality of mirrored pairs of drives.

In yet another embodiment, the reliability weighting comprises an assessment of probability of operation of the physical entity without permanent loss of data.

In a further embodiment, the probability of operation is related to a probability of length of time without permanent loss of data.

In a still further embodiment, the probability of operation is related to static information provided with respect to the data storage physical entity.

In another embodiment, the probability of operation is related to dynamic information derived from previous operation of the data storage physical entity.

In still another embodiment, a computer-implemented method of assigning data storage physical entity mirrored pairings, comprises the steps of:

assigning a reliability weighting to each of a plurality of drives;

sorting the assigned reliability weightings into descending order;

assigning the physical entities having weightings in the upper half of the sorted order to a first set of the drives with greater reliability weighting, and assigning the physical entities having weightings in the lower half of the sorted order to a second set of drives with lesser reliability weighting; and

selecting, for each mirrored pair, one data storage physical entity from the first set and one data storage physical entity from the second set.

For a fuller understanding of the present invention, reference should be made to the following detailed description taken in conjunction with the accompanying drawings.

### BRIEF DESCRIPTION OF THE DRAWINGS

FIG. 1 is a block diagram of an exemplary computer-based RAID data storage system which may implement aspects of the present invention;

FIG. 2 is a block diagram of a PRIOR ART depiction of a RAID 0 data storage and of a RAID 1 data storage arrangement;

FIG. 3 is a diagrammatic illustration of the RAID data storage system of FIG. 1 arranged as RAID 01 and as RAID 10 data storage systems;

FIG. 4 is a flow chart depicting an exemplary method of initiating the operation of the system of FIGS. 1 and 3;

FIGS. 5 and 6 is a diagrammatic illustration of various information regarding the data storage entities of the system of FIGS. 1 and 3;

FIG. 7 is a depiction of a list of data storage entities and their reliability weightings; and

FIG. 8 is a flow chart depicting an exemplary method of operating the system of FIGS. 1 and 3.

### DETAILED DESCRIPTION OF THE INVENTION

This invention is described in preferred embodiments in the following description with reference to the Figures, in which like numbers represent the same or similar elements. While this invention is described in terms of the best mode for achieving this invention's objectives, it will be appreciated by those skilled in the art that variations may be accomplished in view of these teachings without deviating from the spirit or scope of the invention.

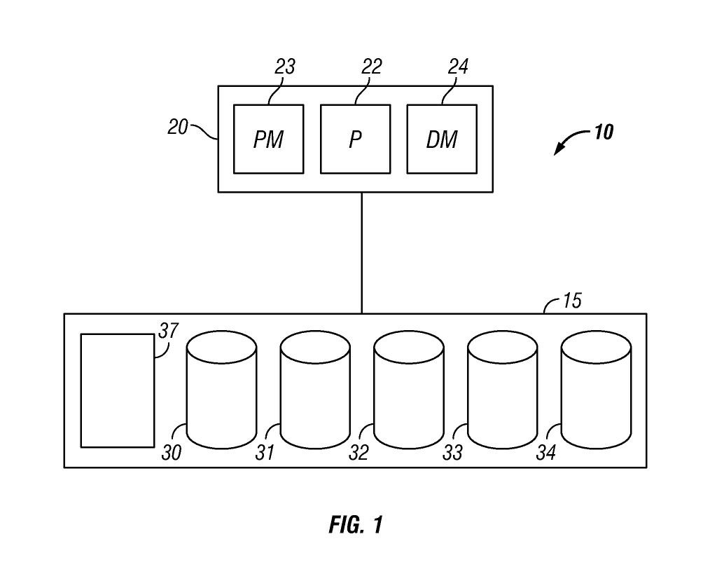

Referring to FIG. 1, an example of a computer-implemented data storage system 10 is illustrated which is arranged for redundancy as a mirrored RAID. The system is one of many computer-implemented mirrored RAID systems which may implement the present invention.

The storage of data on multiple data storage entities 15 is conducted by a control 20. The control comprises at least one computer processor 22 which operates in accordance with computer-usable program code stored in a computer-usable storage medium 23 having non-transient computer-usable program code embodied therein. The computer processor arranges the data storage entities, and stores data to be written to, or that has been read from, the data storage entities in a data memory 24. The control directs the data to locations of the data storage entities so that the data is mirrored, such that two copies of the data are stored by the data storage entities. Alternatively, the data storage functions may be conducted by a host system or server system arranged, inter alia, as control 20 and the data storage entities may comprise individual controls.

The data storage entities 15, for example, comprises a plurality of hard disk drives 30, 31, 32, 33 and 34, or may comprise an electronic memory 37 such as an SSD (solid state drive) as a substitute for one or more hard disk drives. One or more of the data storage entities may be held as a spare.

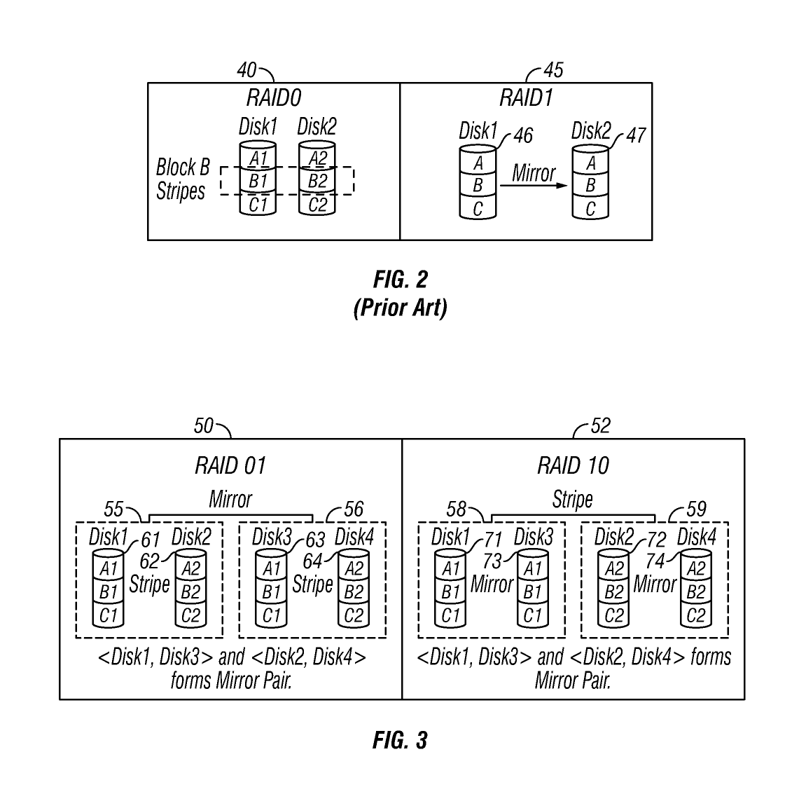

FIG. 2 illustrates arrangements of data storage entities of the prior art in which have been called RAID. RAID (redundant array of independent disks) (also called redundant array of inexpensive disks) is a term applied to pluralities of data storage physical entities arranged to add a redundancy to the data so that the data can be reconstructed even if there is a limited loss of data. A RAID system typically comprises more than one data storage physical entity and the limited loss of data can be up to a catastrophic loss of data on one or more of the data storage physical entities. Numbers are applied to various versions of RAID, some of which copy or “mirror” the data, and others provide “parity” RAID, where data is stored on more than one data storage drive, the data is summed and the parity (which makes the sum of the data, and the parity, equal to all the same bit) is stored separately from the data. An example of a RAID 0 splits data evenly across two or more disks (for example in stripes) with no redundancy by parity or mirroring. It is normally used to increase performance. A RAID 1 45 creates the same data as exact copies (or mirror) of a set of data on two or more physical data storage entities, such as disk drives 46 and 47. This is useful when read performance or reliability is desired, at the expense of data storage capacity. Each half of the mirror contains a complete copy of the data, and can be addressed independently, and ordinary wear-and-tear reliability is extended by the power of the number of self-contained copies.

Referring to FIG. 3, RAID 01 50 and RAID 10 52 combine features of striping of RAID 0 and mirroring of RAID 1 to provide arrays with high performance in many uses and superior fault tolerance. RAID 01 50 is a mirrored arrangement of two striped sets 55 and 56. RAID 10 52 is a stripe across a number of mirrored sets 58 and 59. An advantage of mirroring is the absence of parity calculations, and both RAID 01 and RAID 10 combine the speed of RAID 0 with the redundancy of RAID 1. RAID 01 and RAID 10 comprise a minimum of 4 data storage entities. Herein, any suitable data storage device is considered an “entity”, and the term “drive” or the term “disk”, may also be used without intention to limit the data storage entities to only disk drives.

RAID data storage is provided, for example, as the data storage attached to a DS8000™ Enterprise Storage Server of International Business Machines Corp. (IBM®). The DS8000™ is a high performance, high capacity storage server providing data storage, which may include RAID, that is designed to support continuous operations and implement virtualization of data storage, and is presented herein only by way of embodiment examples and is not intended to be limiting. Thus, the data storage system 10 of FIG. 1 comprises a RAID 01 or a RAID 10 of FIG. 3 as discussed herein and may be implemented with, but is not limited to, data storage of the DS8000™, but may be implemented in any comparable mirrored data storage system, regardless of the manufacturer, product name, or components or component names associated with the system.

In FIG. 1, the algorithm for implementing the RAID 01 or RAID 10 and controlling the data handling is provided by at least one computer processor 22 which operates in accordance with computer-usable program code stored in a computer-usable storage medium 23, as examples, in the form of software, or as implemented in a RAID controller board.

Referring to FIG. 3, the reliability of a RAID array depends on the lifetime of the drives of the RAID array. In the case of RAID 01 50 or RAID 10 52, the lifetime of the array is based on the lifetime of the mirror pair with minimum lifetime value, where the lifetime of a mirror pair is equal to the lifetime of the longest lived drive in the pair. This means that the data is still retrievable so long as the data may be retrieved from one drive of the mirrored pair.

Thus, in FIG. 3, for RAID 01 or RAID 10, if there are four drives with two mirror pairs as,

Mirror_Pair1: <Drive1 61,71, Drive3 63,73>

Mirror_Pair2: <Drive2 62,72, Drive4 64,74>

Reliability of RAID array=Min (Lifetime of Mirror_Pair1, Lifetime of Mirror_Pair2)

Lifetime of Mirror_Pair1=Max (Lifetime of Drive1 61,71, Lifetime of Drive3 63,73)

Lifetime of Mirror_Pair2=Max (Lifetime of Drive2 62,72, Lifetime of Drive4 64,74)

The assignment of the mirrored pairing of drives comprises arranging the drives in mirrored pairs in accordance with reliability weightings assigned to each of the plurality of drives. Each mirrored pair comprises one of the drives with at least a median and greater reliability weighting, and one of the drives with at least a median and lesser reliability weighting.

Thus, each mirrored pair has at least one drive with at least a median and greater reliability weighting, assuring that each mirrored pair will have at least a median and greater reliability and therefore a likely longer lifetime than if the drives were assigned on another basis.

For example, during the setup phase of the RAID system, such as by the RAID control 20, a system or application associated with the control, collects information about the health statistics of all the drives 61, 62, 63, 64, 71, 72, 73, 74 participating in the formation of the RAID array 50, or 52.

In the example of magnetic disk drives, examples of health information may include QoS (Quality of Service) information provided by the disk drive manufacturer for the type and model of disk drive. This information may be called “static” information. Other information may be derived from S.M.A.R.T. (Self Monitoring, Analysis and Reporting Technology) measured by the disk drive itself as defined by the disk drive manufacturer. This information changes as the drive is being used and may be called “dynamic” information.

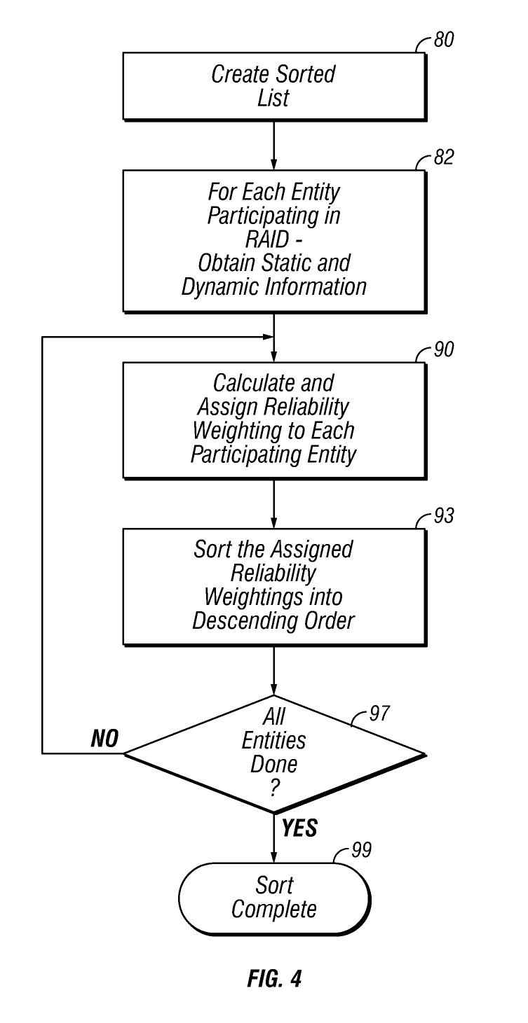

Referring to FIG. 4, a sorted list is initiated 80 for the drives of the RAID array. In step 82, the health information, such as discussed above, is obtained for each of the drives participating in the RAID array.

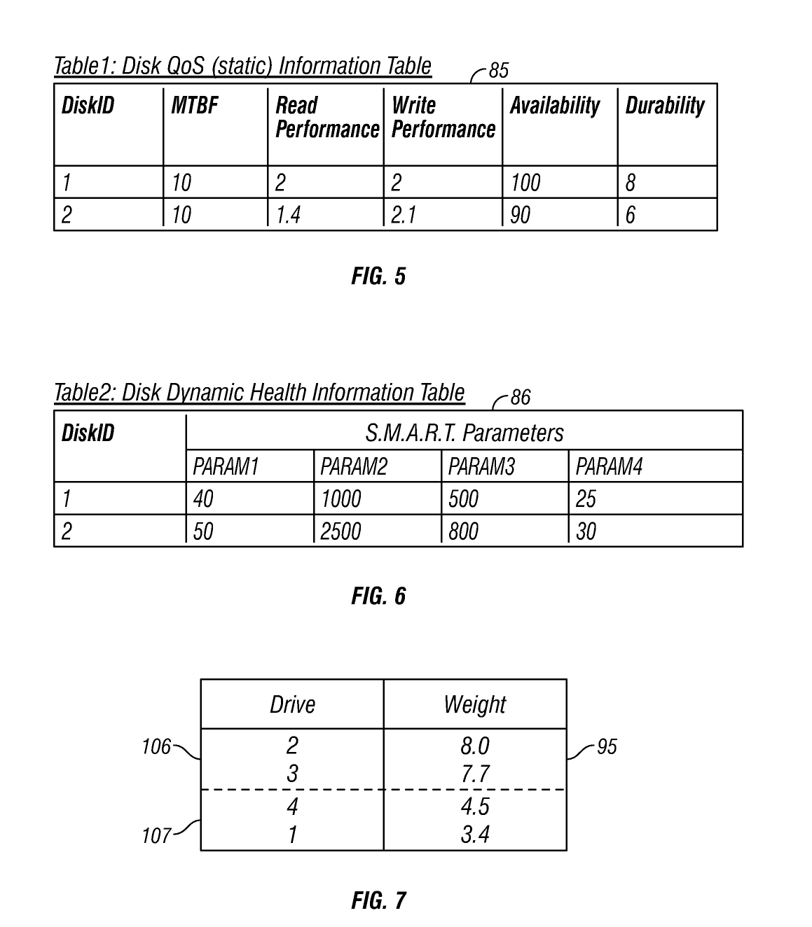

FIGS. 5 and 6 present examples of information that may be gathered in step 82, including static information 85 and dynamic information 86. Common examples of static QoS information 85 comprise, in the example of magnetic disk drives, availability, durability, mean time between failure (MTBF), read performance and write performance. Common examples of dynamic information 86, in the example of magnetic disk drives, are:

Head Flying Height—A downward trend in flying height will often presage a head crash.

Number of Remapped Sectors—If the drive is remapping many sectors due to internally detected errors, this can mean that the drive is approaching failure.

ECC (Error Correction Code) and Error Counts—The number of errors encountered by the drive, even if corrected internally, often signals problems developing with the drive. The trend is in some cases more important than the actual count.

Spin-Up Time—Changes in spin-up time can reflect problems with the spindle motor.

Temperature—Increases in drive temperature often signal spindle motor problems.

Data Throughput—Reduction in the transfer rate of the drive can signal various internal problems.

The dynamic information 86 is updated periodically and when the device is added to the storage system.

The gathered information may be stored and updated, for example, in a table as illustrated in FIGS. 5 and 6.

In FIG. 4, information gathered in step 82 is used in step 90 to calculate and assign a reliability weighting to each entity participating in the RAID array.

An example of the calculation of weighting formula comprises:

Weighting of the entity=β*StaticParameterValue+d*DynamicParameterValue

where, in an example of magnetic disk drives:

StaticParameterValue=β1*MTBF+β2*ReadPerformance+β3*other QoS+ . . .

DynamicParameterValue=d1*SMART1+d2*SMART2+d3*SMART3+ . . .

The parameters utilized in the collection and the values to accomplish the weighting are designed to create a reliability weighting that comprises an assessment of the probability of operation of the physical entity without permanent loss of data, and the probability of operation is related to a probability of length of time without permanent loss of data.

The values of β, d, β1, β2, β3, . . . , d1, d2, d3, . . . are defined by the user and/or the system, and may be based on preference or requirements. The values are established to give balance and preference to the various parameters, e.g. MTBF may be a ratio with respect to 100 years, read performance may be a ratio with respect to 2 MB/s (megabytes per second), etc.

Referring to FIGS. 4, 5, 6 and 7, in step 90, the information about each entity is obtained from the tables 85 and 86, to get the static and dynamic parameters and the weighting of each entity is calculated, for example using the above formula. In step 93, an empty sorted list 95 is created, and each entity is added to the sorted weighting list in descending sorted order.

Step 97 determines whether all of the entities participating in the RAID array have been weighted and added to the sorted list 95. If not, the process proceeds back to step 93 to calculate and assign the reliability weighting to the next entity and add the listing of the entity to the sorted list 95. When step 97 indicates that all of the entities have been added to the sorted list, step 99 indicates that the sort provided in list 95 is complete for all of the entities participating in the RAID array.

These reliability weightings provide an assessment of probability of length of time of operation of the physical entity without permanent loss of data. Thus, in the example of FIG. 7, the weightings may be the anticipated number of years of each drive without permanent loss of data.

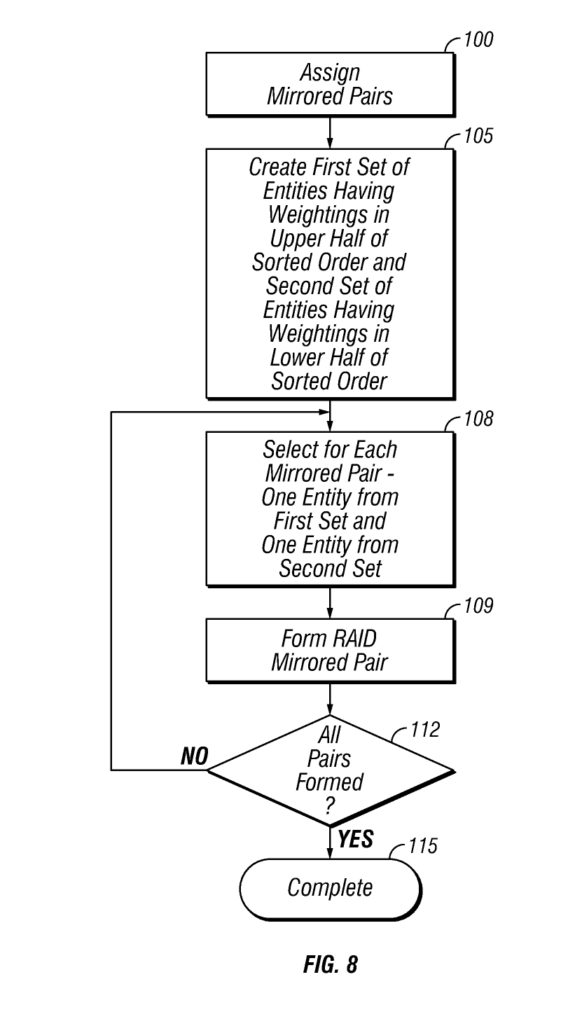

Referring to FIGS. 7 and 8, the process 100 for assigning mirrored pairs for the RAID array involves creating two equal sized sets of physical entities. In step 105, a first set of entities is created having weightings in the upper half of the sorted order of sorted list 95. The reliability weightings in list 95 provide an assessment of probability of length of time of operation of the physical entity without permanent loss of data, for example, shown in years. Thus, the weightings of data storage drive 2 of 8.0 years, and of data storage drive 3 of 7.7 years rank in the top half of the sorted order of list 95. Also in step 105, a second set of entities is created having weightings in the lower half of the sorted order of sorted list 95. The weightings of data storage drive 4 of 4.5 years, and of data storage drive 1 of 3.4 years rank in the bottom half of the sorted order of list 95.

To provide mirrored pairs, it is necessary that the data storage physical entities participating in the RAID array comprises an even number. Thus, the division of the list 95 into two sets of equal size comprising the upper 106 and lower 107 halves of the list is an example of a way to equalize the number of data storage physical entities at each side of the RAID mirrors. Should the lowest ranked physical entity of the set 106 comprising the upper half of the sorted list have the same reliability weighting as the highest ranked physical entity of the set 107 comprising the lower half of the sorted list, the entities are assigned to the first or second set of entities by some other means, such as by random selection or by drive number sequence. Another way of approaching the division of the list is that the set 106 comprising the upper half of the list comprises physical entities having at least a median and greater reliability weighting, and the set 107 comprising the lower half of the list comprises data storage physical entities having at least a median and lesser reliability weighting. Any drive having a median reliability rating is arranged at the side of a mirrored pair required to equalize the number of drives at each side of the arrangement. Thus, if two drives have the same median reliability weighting, one is assigned to the upper half set, and the other is assigned to the lower half set.

The selection of the mirrored pairs is accomplished in steps 108 and 109. For each mirrored pair, in step 108, one entity is selected from the first set 106 of physical entities and one entity is selected from the second set 107 of physical entities. In step 109, the selected physical entities are designated as forming a RAID mirrored pair. For example, in step 108, drive 2 is selected from set 106 and drive 4 is selected from set 107, and step 109 forms a mirrored pair of drive 2 and drive 4, as shown in FIG. 3. Step 112 determines whether all the pairs of the RAID array have been formed, and, if not, steps 108 and 109 are repeated. For example, in step 108, drive 3 is selected from set 106 and drive 1 is selected from set 107, and step 109 forms a mirrored pair of drive 1 and drive 3, as shown in FIG. 3. Step 112 determines that all the pairs of the RAID array have been formed, completing the RAID array arrangement in step 115.

The result is that the RAID array, by virtue of the placement of one of the data storage physical entities with at least a median and greater said reliability weighting in each mirrored pair, assures that each pair in the array has an entity with the longest potential lifetime, and that the RAID array has the potential lifetime dictated by an entity from the set of drives having the minimum of the longest potential lifetimes.

To put the statement in perspective, using the algorithm discussed above:

In FIG. 3, for RAID 01 or RAID 10, if there are four drives with two mirror pairs as,

Mirror_Pair1: <Drive1 61,71, Drive3 63,73>

Mirror_Pair2: <Drive2 62,72, Drive4 64,74>

Lifetime of Mirror_Pair1=Max (Lifetime of Drive1 61,71, Lifetime of Drive3 63,73)

Lifetime of Mirror_Pair2=Max (Lifetime of Drive2 62,72, Lifetime of Drive4 64,74)

Reliability of RAID array=Min (Lifetime of Mirror_Pair1, Lifetime of Mirror_Pair2)

Inserting the lifetimes of the reliability weightings:

Thus, in FIG. 3, for RAID 01 or RAID 10, if there are four drives with two mirror pairs as,

Mirror_Pair1: <Drive1 (3.4), Drive3 (7.7)>

Mirror_Pair2: <Drive2 (8.0), Drive4 (4.5)>

Lifetime of Mirror_Pair1=Max (Lifetime of Drive1 (3.4), Lifetime of Drive3 (7.7)=7.7

Lifetime of Mirror_Pair2=Max (Lifetime of Drive2 (8.0), Lifetime of Drive4 (4.5)=8.0

Reliability of RAID array=Min (Lifetime of Mirror_Pair1=7.7), Lifetime of Mirror_Pair2=8.0)=7.7

This results in a potential lifetime of 7.7.

The process may be implemented with various numbers (even numbers) of physical data storage entities to form various numbers of mirrored pairs within a RAID array.

A person of ordinary skill in the art will appreciate that the embodiments of the present invention, disclosed herein, including the computer-implemented system 10 for storage of data in RAID arrays of FIG. 1, and the functionality provided therein, may be embodied as a system, method or computer program product. Accordingly, embodiments of the present invention may take the form of an entirely hardware embodiment, an entirely software embodiment (including firmware, resident software, micro-code, etc.) or a combination thereof, such as an embodiment combining software and hardware aspects that may all generally be referred to herein as a “circuit,” “module” or “system.” Furthermore, embodiments of the present invention may take the form of a computer program product embodied in one or more non-transient computer readable medium(s) having computer readable program code embodied thereon.

Any combination of one or more non-transient computer readable medium(s) may be utilized. The computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Those of skill in the art will understand that changes may be made with respect to the methods discussed above, including changes to the ordering of the steps. Further, those of skill in the art will understand that differing specific component arrangements may be employed than those illustrated herein.

While the preferred embodiments of the present invention have been illustrated in detail, it should be apparent that modifications and adaptations to those embodiments may occur to one skilled in the art without departing from the scope of the present invention as set forth in the following claims.

What is claimed is:

1. A mirrored arrangement of data storage physical entities, comprising:
a plurality of said data storage physical entities arranged in mirrored pairs in accordance with reliability weightings assigned to each of said plurality of data storage physical entities; each said mirrored pair comprising one of said data storage physical entities with at least a median and greater said reliability weighting, and one of said data storage physical entities with at least a median and lesser said reliability weighting.

2. The mirrored arrangement of claim 1, wherein said plurality of data storage physical entities comprises an even number, and any said data storage physical entity having a median said reliability weighting is arranged at the side of a mirrored pair required to equalize the number of data storage physical entities at each side of said arrangement.

3. The mirrored arrangement of claim 2, wherein said mirrored pairs are arranged as a RAID 01 arrangement having two groups of said data storage physical entities, a first group of said data storage physical entities of said median and greater reliability weightings of said mirrored pairs, and said second group of said data storage physical entities of said median and lesser reliability weightings, to form said mirrored pairs.

4. The mirrored arrangement of claim 2, wherein said mirrored pairs are arranged as a RAID 10 arrangement having a plurality of said mirrored pairs of said data storage physical entities.

5. The mirrored arrangement of claim 2, wherein said reliability weighting comprises an assessment of probability of operation of said physical entity without permanent loss of data.

6. The mirrored arrangement of claim 5, wherein said probability of operation is related to a probability of length of time without permanent loss of data.

7. The mirrored arrangement of claim 6, wherein said probability of operation is related to static information provided with respect to said data storage physical entity.

8. The mirrored arrangement of claim 6, wherein said probability of operation is related to dynamic information derived from previous operation of said data storage physical entity.

9. A mirrored data storage system comprising:
a RAID control system; and
a plurality of data storage physical entities arranged in mirrored pairs in accordance with reliability weightings assigned to each of said plurality of data storage physical entities; each said mirrored pair comprising one of said data storage physical entities with at least a median and greater said reliability weighting, and one of said data storage physical entities with at least a median and lesser said reliability weighting.

10. The mirrored data storage system of claim 9, wherein said plurality of data storage physical entities comprises an even number, and any said data storage physical entity having a median said reliability weighting is arranged at the side of a mirrored pair required to equalize the number of data storage physical entities at each side of said arrangement.

11. The mirrored data storage system of claim 10, wherein said mirrored pairs are arranged as a RAID 01 data storage system having two groups of said data storage physical entities, a first group of said data storage physical entities of said median and greater reliability weightings of said mirrored pairs, and said second group of said data storage physical entities of said median and lesser reliability weightings, to form said mirrored pairs.

12. The mirrored data storage system of claim 10, wherein said paired mirrored sets are arranged as a RAID 10 data storage system having a plurality of said mirrored pairs of said data storage physical entities.

13. The mirrored data storage system of claim 10, wherein said reliability weighting comprises an assessment of probability of operation of said physical entity without permanent loss of data.

14. The mirrored data storage system of claim 13, wherein said probability of operation is related to a probability of length of time without permanent loss of data.

15. The mirrored data storage system of claim 14, wherein said probability of operation is related to static information provided with respect to said data storage physical entity.

16. The mirrored data storage system of claim 14, wherein said probability of operation is related to dynamic information derived from previous operation of said data storage physical entity.

17. A computer-implemented method of assigning data storage physical entity mirrored pairings, comprising the steps of:
assigning a reliability weighting to each of a plurality of data storage physical entities; and
sorting said assigned reliability weightings into descending order;
assigning said physical entities having weightings in the upper half of said sorted order to a first set of said data storage physical entities with high said reliability weighting, and assigning said physical entities having weightings in the lower half of said sorted order to a second set of said data storage physical entities with lesser said reliability weighting; and
selecting, for each said mirrored pair, one said data storage physical entity from said first set and one said data storage physical entity from said second set.

18. The method of claim 17, wherein said reliability weighting comprises an assessment of probability of operation of said physical entity without permanent loss of data.

19. A computer program product for selecting an arrangement of data storage physical entities for a mirrored data storage system by at least one computer-implemented processor, said computer program product comprising computer-usable storage medium having non-transient computer-usable program code embodied therein, comprising computer-usable program code for said processor:
to assign a reliability weighting to each of a plurality of data storage physical entities;
to sort said assigned reliability weightings into descending order;
to assign said data storage physical entities having weightings in the upper half of said sorted order to a first set if said data storage physical entities with high said reliability weighting, and to assign said data storage physical entities having weightings in the lower half of said sorted order to a second set of data storage physical entities with lesser said reliability weighting; and
to select, for each said mirrored pair, one said data storage physical entity from said first set and one said data storage physical entity from said second set.

20. The computer program product of claim 19, wherein said reliability weighting comprises an assessment of probability of operation of said data storage physical entity without permanent loss of data.
